(19) United States
(12) Patent Application Publication
(10) Pub. No.: US 2014/0121933 A1
(43) Pub. Date: May 1, 2014

(54) FLEXIBLE MAXIMUM VEHICLE SPEED METHOD

(71) Applicant: PACCAR Inc, Bellevue, WA (US)

(72) Inventors: Zachary Slaton, Seattle, WA (US); Christopher Balton, Bellingham, WA (US); Michael Repko, Bow, WA (US); Suresh Kumar, Issaquah, WA (US)

(21) Appl. No.: 13/665,565

(22) Filed: Oct. 31, 2012

(51) Int. Cl. B60K 31/00

(52) U.S. Cl. CPC B60K 31/00
USPC 701/93

(57) ABSTRACT

In accordance with aspects of the present disclosure, a method of limiting a vehicle speed is provided. The method includes limiting the speed of the vehicle to a predetermined limit under normal operating conditions. The method further includes selectively engaging an override condition in response to an operator generated input. During the override condition, the vehicle can exceed the predetermined limit by a specified offset. The override condition is not available when the vehicle has traveled in the override condition for a predetermined number of miles.

### BACKGROUND

Current federal regulations for new heavy-duty motor vehicles set standards for allowable greenhouse gas (GHG) emissions. Included in these regulations are provisions related to vehicle speed limiters (VSLs), which actively limit vehicle speed to a maximum speed that depends on vehicle programming and operating conditions. Because vehicles tend to be more fuel efficient at lower speeds, limiting a vehicle's maximum speed with a VSL increases the overall fuel efficiency of the vehicle and decreases the GHG emissions of the vehicle. In addition to increasing GHG emissions, operating a vehicle at higher maximum speeds can result in higher fuel consumption and, thus, may result in increased operating costs. In the field of surface transportation and particularly in the long-haul trucking industry, even small improvements in fuel efficiency can reduce annual operating costs significantly.

One known technique for limiting vehicle speed includes the use of a vehicle speed governor that prevents the engine from rotating above a predetermined engine speed. This technique, however, may be too limiting to the driver for some applications and thus, may frustrate the driver and restrict the driver's ability to control the vehicle. For example, under certain circumstances, avoiding hazards may require that the operator exceed this predetermined speed for a limited period of time in order to execute an evasive maneuver. In addition, normal operating maneuvers, such as passing, may also require that operator exceed the maximum vehicle speed for a short time in order to more safely pass another vehicle. Thus, there is a need for a vehicle speed limiters that reduce GHG emissions and improve vehicle operating efficiency, while still giving the vehicle operator the flexibility to exceed this speed for limited amounts of time, distance, or both.

### SUMMARY

In accordance with aspects of the present disclosure, a first embodiment of a method of limiting a vehicle speed is provided. The method includes limiting the speed of the vehicle to a predetermined limit under normal operating conditions. The method further includes selectively engaging an override condition in response to an operator generated input. During the override condition, the vehicle can exceed the predetermined limit by a specified offset. The override condition is not available when the vehicle has traveled in the override condition for a predetermined number of miles over a predetermined distance or time, whichever is less.

A second embodiment of a method of limiting a vehicle speed includes limiting the vehicle speed to a predetermined limit during a standard operating mode. The method further includes providing an operator input to selectively engage an override mode, the vehicle speed exceeding the predetermined speed limit during the override condition and then disengaging the override mode when a predetermined disengagement condition is met.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of disclosed subject matter will become more readily appreciated as the same become better understood by reference to the following detailed description, when taken in conjunction with the accompanying drawings, wherein:

FIG. 1 is a schematic diagram of one example of a vehicle suitable for comprising a vehicle speed limiter in accordance with aspects of the present disclosure;

FIG. 2 is a schematic diagram of one example of the vehicle speed limiter of FIG. 1;

FIG. 3A-3B show a flow diagram of a first exemplary embodiment of a method of controlling the speed of a vehicle that may be implemented by one or more components of the vehicle speed limiter of FIG. 2;

FIG. 4A-4B show a flow diagram of a second exemplary embodiment of a method of controlling the speed of a vehicle that may be implemented by one or more components of the vehicle speed limiter of FIG. 2;

FIG. 5A is a first example of an operator display in a first state according to the method shown in FIGS. 3A-3B;

FIG. 5B is a second example of an operator display in the first state according to the method shown in FIGS. 3A-3B;

FIG. 6A is an example of an operator display in a second state according to the method shown in FIGS. 3A-3B;

FIG. 6B is an example of an operator display in the second state according to the method shown in FIGS. 3A-3B;

FIG. 7A is an example of an operator display in a third state according to the method shown in FIGS. 3A-3B;

FIG. 7B is an example of an operator display in the third state according to the method shown in FIGS. 3A-3B;

FIG. 8A is an example of an operator display in a fourth state according to the method shown in FIGS. 3A-3B;

FIG. 8B is an example of an operator display in the fourth state according to the method shown in FIGS. 3A-3B;

FIG. 9A is an example of an operator display in a fifth state according to the method shown in FIGS. 3A-3B;

FIG. 9B is an example of an operator display in the fifth state according to the method shown in FIGS. 3A-3B;

FIG. 10A is an example of an operator display in a sixth state according to the method shown in FIGS. 3A-3B;

FIG. 10B is an example of an operator display in the sixth state according to the method shown in FIGS. 3A-3B;

FIG. 11 is a flow diagram of an exemplary method of activating the vehicle speed limiter of FIG. 1.

### DETAILED DESCRIPTION

The detailed description set forth below in connection with the appended drawings where like numerals reference like elements is intended only as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

Although the present disclosure is described hereinafter with reference to Class 8 trucks, it will be appreciated that aspects of the present disclosure have wide application, and therefore, may be suitable for use with many types of mechanically powered, electric, or hybrid powered vehicles, such as passenger vehicles, buses, commercial vehicles, light and medium duty vehicles, etc. Accordingly, the following descriptions and illustrations herein should be considered illustrative in nature, and thus, not limiting the scope of the claimed subject matter.

Prior to discussing the details of various aspects of the present disclosure, it should be understood that several sections of the following description are presented largely in terms of logic and operations that may be performed by conventional electronic components. These electronic components, which may be grouped in a single location or distributed over a wide area, generally include processors, memory, storage devices, display devices, input devices, etc. It will be appreciated by one skilled in the art that the logic described herein may be implemented in a variety of hardware, software, and combination hardware/software configurations, including but not limited to, analog circuitry, digital circuitry, processing units, and the like. In circumstances were the components are distributed, the components are accessible to each other via communication links.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to obscure unnecessarily various aspects of the present disclosure. Furthermore, it will be appreciated the embodiments of the present disclosure may employ any of the features described herein.

The present disclosure describes examples of variable speed limiters and methods thereof suitable for use in vehicles, such as Class 8 trucks. Generally, the examples of the variable speed limiters and methods described herein aim to provide a Legal Speed Limit (LSL), which is the maximum vehicle speed under normal operating conditions. The LSL is generally controlled by the truck original equipment manufacturer (OEM) and is specified by the customer to ensure all governmental regulations and/or fleet fuel economy goals are being met. However, recognizing that it is sometimes allowable and advantageous to exceed the LSL, the disclosed VSL includes a “Soft Top Speed Limiter” (SSL) that allows a vehicle operator to exceed the values of the LSL under certain operating conditions. That is, the VSL is configured with a reserve speed that allows the operator to exceed the LSL by up to a predetermined SSL offset speed. The SSL offset speed is conditionally available to the vehicle operator to temporarily increases the maximum vehicle speed to a “Soft Top Speed Limit” (STSL), wherein STSL=LSL+SSL offset. As will be discussed in detail below, the availability of the reserve speed depends upon various programmed parameters, as well as the vehicle operating history.

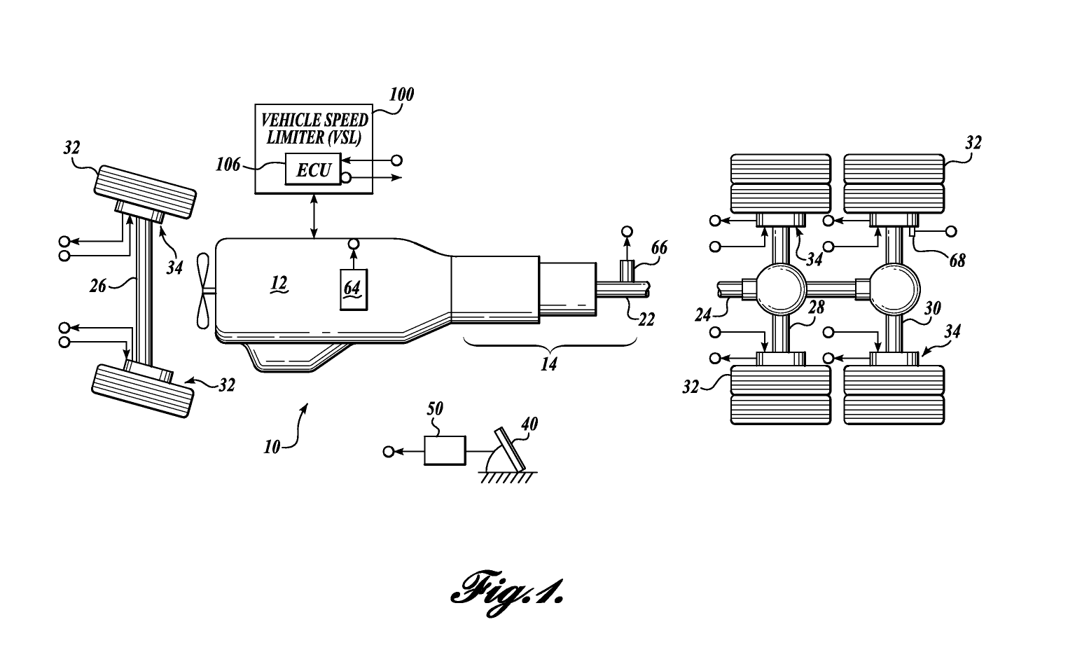

As briefly described above, the present disclosure is directed to embodiments of vehicle speed management systems. FIG. 1 is a schematic diagram of a vehicle 10, such as a Class 8 tractor, suitable for comprising a vehicle speed limiter 100 in accordance with one embodiment of the present disclosure. Although a vehicle such as depicted in FIG. 1 represents one exemplary application for the systems and methods of the present disclosure, it should be appreciated that aspects of the present disclosure transcend any particular type of vehicle employing an internal combustion engine (e.g., gas, diesel, etc.), hybrid drive train, or electric motor.

The vehicle 10 in the exemplary embodiment shown in FIG. 1 includes an electronically controlled engine 12 coupled to a known transmission 14. The transmission 14 has an output shaft 22 coupled to a drive shaft 24. The vehicle 10 has at least two axles, including as a steer axle 26 and one or more drive axles, such as axles 28 and 30. Each axle supports corresponding wheels 32 having service brake components 34 for monitoring the vehicle's operating conditions and to effect control of the vehicle braking system. The vehicle 10 also includes various operator control inputs, such as an accelerator pedal 40, a clutch pedal (not shown), and a steering wheel (not shown). In addition, the vehicle 10 has one or more of sensors, such an accelerator pedal position sensor 50, an engine speed sensor 64, an output shaft sensor 66, and wheel speed sensor 68. As indicated above, the vehicle 10 is further equipped with a VSL 100 that includes a one or more electronic control units (ECU) 106. The ECU 106 interfaces with the engine 12 and the various sensors described herein and is configured to control the engine to limit the speed of the vehicle. It will be appreciated that the described vehicle is exemplary only and should not be considered limiting. In this regard, alternate vehicles configurations that include have different numbers and types of axles, operator control inputs, sensors, and other components, are contemplated and should be considered within the scope of the present disclosure.

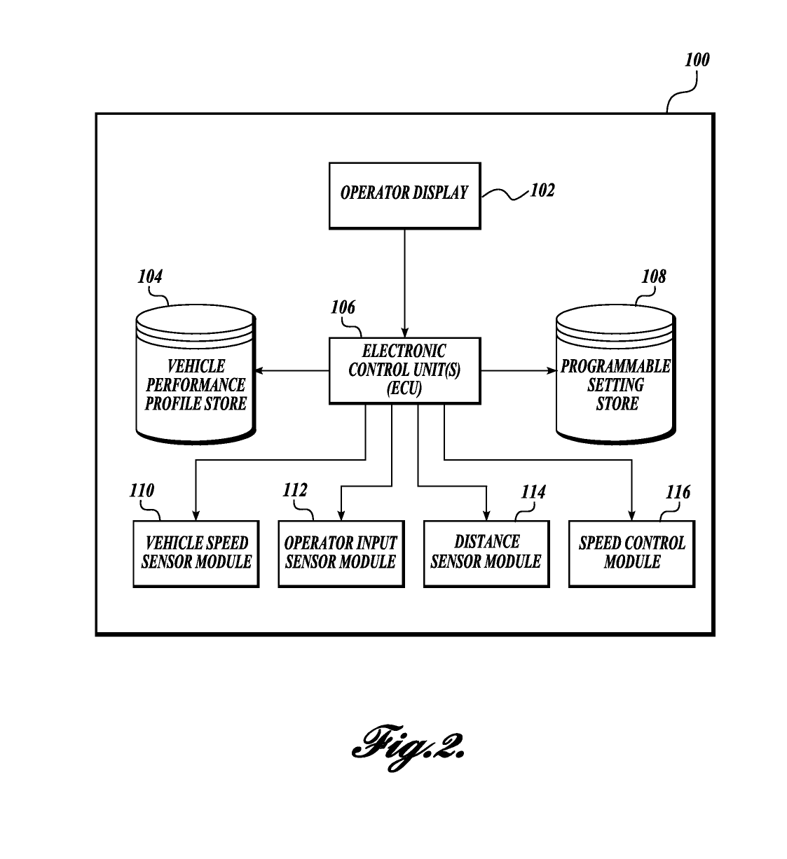

FIG. 2 illustrates one embodiment of a VSL 100 according to various aspects of the present disclosure. The VSL 100 includes an electronic control unit (ECU) 106 that monitors vehicle status and causes a VSL status indicator to be presented by an operator display 102 when appropriate. The operator display 102 may be any type of display used in a vehicle to convey information to the operator. For example, the operator display 102 may include an LCD video screen display configured to display information to the operator much as any other computing display. As another example, the operator display 102 may include special purpose lighted displays, needle gauges, and/or the like. The operator display 102 may also include speakers or haptic feedback devices, such as vibrating motors, to provide information to the operator via audible or tactile means

It will be appreciated that the ECU 106 can be implemented in a variety of hardware, software, and combination hardware/software configurations, for carrying out aspects of the present disclosure. In one embodiment, the ECU 106 may include a memory and a processor. In one embodiment, the memory comprises a random access memory (“RAM”) and an electronically erasable, programmable, read-only memory (“EEPROM”). Those of ordinary skill in the art and others will recognize that the EEPROM may be a non-volatile memory capable of storing data when a vehicle 10 is not operating. The RAM may be a volatile form of memory for storing program instructions that are accessible by the processor. Typically, a fetch and execute cycle in which instructions are sequentially “fetched” from the RAM and executed by the processor is performed. In this regard, the processor is configured to operate in accordance with program instructions that are sequentially fetched from the RAM. The memory may include program modules, applications, instructions, and/or the like that are executable by the processor.

Still referring to FIG. 2, the ECU 106 is communicatively coupled to a plurality of sensors that provide status information concerning various states of the vehicle 10. For example, in the disclosed embodiment, the ECU 106 is communicatively coupled to a vehicle speed sensor module 110 configured to provide real time data about vehicle speed. The vehicle speed sensor module 110 can take the form of the previously mentioned wheel speed sensor 68, or can be a separate sensor that uses a known method to sense vehicle speed.

In the illustrated embodiment, the ECU 106 is also communicatively coupled to one or more operator input sensor modules 112 configured to provide vehicle operator input to the ECU 106. In one embodiment, the operator input sensor is the previously mentioned accelerator pedal position sensor 50; however it should be appreciated that any number of known operator input sensors can be utilized, including buttons, toggles, video touch-screens, keyboards, mechanical levers, and any other known devices that allow an operator to provide input to the ECU 106.

The ECU 106 can also be communicatively coupled to a distance sensor module 114 configured to provide information regarding the distance that a vehicle has traveled over its lifetime, as well as over predetermined periods. In one embodiment, the distance sensor module 114 retrieves data from the vehicle odometer or from the same sensors that provide information to the vehicle odometer. The distance sensor module 114 may also be configured to provide vehicle distance traveled over a 24 hour period, during one calendar day, or during any other desired time span.

Still referring to FIG. 2, the ECU 106 is connected to a speed control module 116. The speed control module limits the vehicle speed in accordance with the features of the vehicle speed limiter 100. In one embodiment, the speed control module 116 is a governor that electronically controls maximum vehicle speed according to input received from the ECU 106. Electronically controlled governors for controlling vehicle speed are known in the art, and it will be apparent that the present disclosure is not limited to any particular governor. In this regard, any known device for controlling maximum vehicle speed that can be electronically controlled can be configured for use with the present vehicle speed limiter 100, and the use of such governors should be considered within the scope of the present disclosure.

The components described herein as “communicatively coupled” may be coupled by any suitable means. In one embodiment, components may be connected by an internal communications network such as a vehicle bus that uses a controller area network (CAN) protocol, a local interconnect network (LIN) protocol, and/or the like. Those of ordinary skill in the art will recognize that the vehicle bus may be implemented using any number of different communication protocols such as, but not limited to, Society of Automotive Engineers (“SAE”) J1587, SAE J1922, SAE J1939, SAE J1708, and combinations thereof. In other embodiments, components may be connected by other networking protocols, such as Ethernet, Bluetooth, TCP/IP, and/or the like. In still other embodiments, components may be directly connected to each other without the use of a vehicle bus, such as by direct wired connections between the components. Embodiments of the present disclosure may be implemented using other types of currently existing or yet-to-be-developed in-vehicle communication systems without departing from the scope of the claimed subject matter.

The illustrated ECU 106 is also communicatively coupled to a vehicle performance profile store 104 and a programmable setting store 108. Each of the stores includes a computer-readable storage medium that has stored thereon the data described herein. One example of a store is a hard disk drive, but any other suitable nonvolatile computer-readable storage medium, such as an EEPROM, flash memory, and/or the like may be used.

In one embodiment, the vehicle performance profile store 104 stores data regarding past vehicle use that can be used to determine whether or not the Soft Spot Speed Limit is available, i.e., if the SSL may be activated. Such information will include the number of miles driven above the LSL during the lifetime of the vehicle and also on a daily basis. It will be appreciated that other performance information can be stored in the vehicle performance profile store as necessary to implement various embodiments of the disclosed VSL.

The programmable setting store 108 is configurable to store one or more settings that may be used by the ECU 106 to determine conditions under which the shift indicator should be presented. The one or more settings may be set to a default value, or may be reset to a different value. In one embodiment, the programmable setting store 108 may also store a lower bound value and an upper bound value for each setting. In one embodiment each setting may be changed via a user interface provided within the vehicle 10. In another embodiment, each setting may be programmed during manufacture of the vehicle 10, via a service tool, etc.

An exemplary method for utilizing a VSL as described herein to provide a flexible maximum vehicle speed will be described. The description makes reference to various vehicle operating parameters that can be sensed and stored during vehicle operation, as well as programmable settings that can be programmed into the VSL by the vehicle manufacturer, the owner, the operator, or any other suitable entity. The programmable settings are determined in accordance with legal requirements that govern vehicle operation, as well as owner and/or operator requirements. For the sake of clarity, acronyms and definitions for various operational parameters and programmed settings are set forth below. The terms listed and the definitions provided are exemplary only. It will be appreciated that actual parameters and settings utilized during operation of the VSL can vary within the scope of the claims subject matter.

V_{actual}: This is the vehicle's actual road speed.

Vehicle Total Distance: This is the total mileage accrued by the truck throughout its life.

Legal Set Speed (LSS): This setting is the legally specified maximum set speed derived from the legal speed limit and corrected for tolerances.

Legal Speed Limit (LSL): This setting is the absolute maximum vehicle speed to be controlled by the truck original equipment manufacturer (OEM) and specified by the customer to ensure all governmental regulations are being met.

Vₘₐₓ: This setting is the maximum powered vehicle speed when there are no offsets present (cruise control offsets, gear down protection, or driver reward offsets, etc.), and V_{actual}≦LSL.

SSL Offset: This setting is vehicle speed offset that may be applied to the LSL when SSL functionality is activated.

Cycle_{Soft Top}: This setting is a finite operating cycle of the truck used in calculation of the SSL Daily Distance. The Cycle_{Soft Top} is calculated as (1) any vehicle operation that is bound before or after by a period of four continuous hours in which the vehicle is stationary; or (2) vehicle operation in which Distance traveled=(SSL Max Daily Distance+calibrated threshold); whichever occurs first.

SSL Daily Distance Limit: This is the maximum accumulated distance over Cycle_{Soft Top} that a vehicle may travel above LSL and still activate the soft top vehicle speed.

SSL Max Daily Distance: This is the maximum regulation-specified value for the SSL Daily Distance Limit.

VSL Expiration Distance: This is a programmable parameter that allows a customer to specify the mileage at which they would like to have the option of de-activating the GHG-compliant VSL settings that were selected at the point of sale from the vehicle manufacturer.

Soft Top Speed Limit Total Distance (STSLTD): This is the total distance accrued throughout the truck's life when V_{actual}>LSL and the engine is fueled.

The above settings and parameters are exemplary only. In other contemplated embodiments, more or fewer variables may be stored in the vehicle performance profile store 104 and/or programmable setting store 108. Moreover, the values stored therein may also vary.

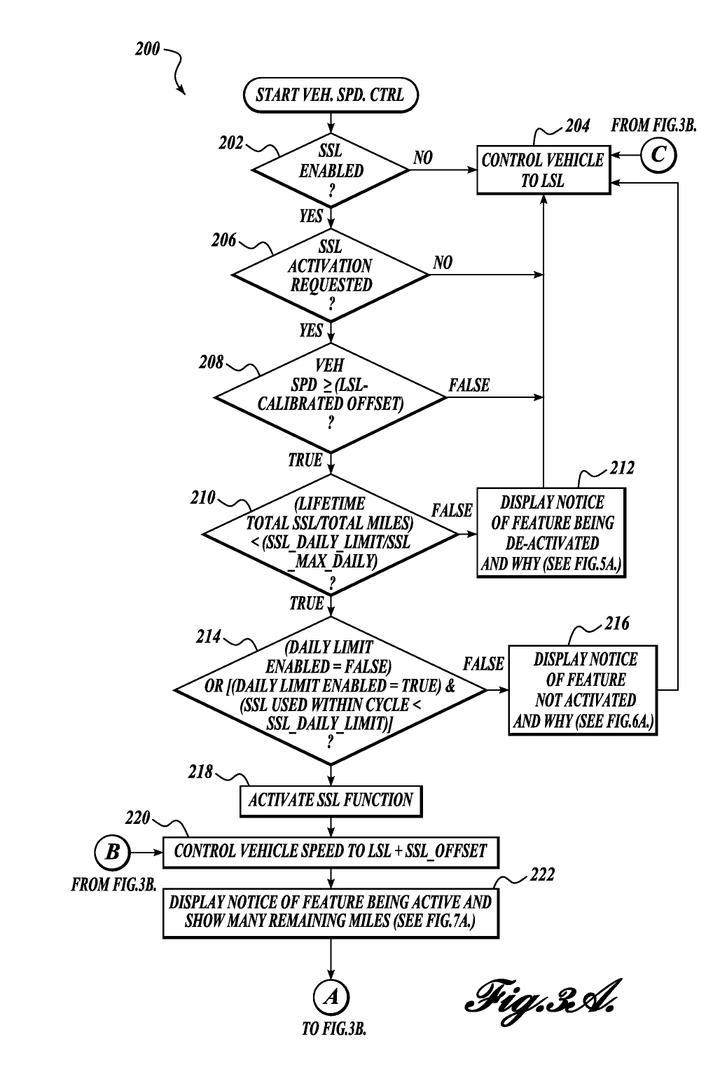

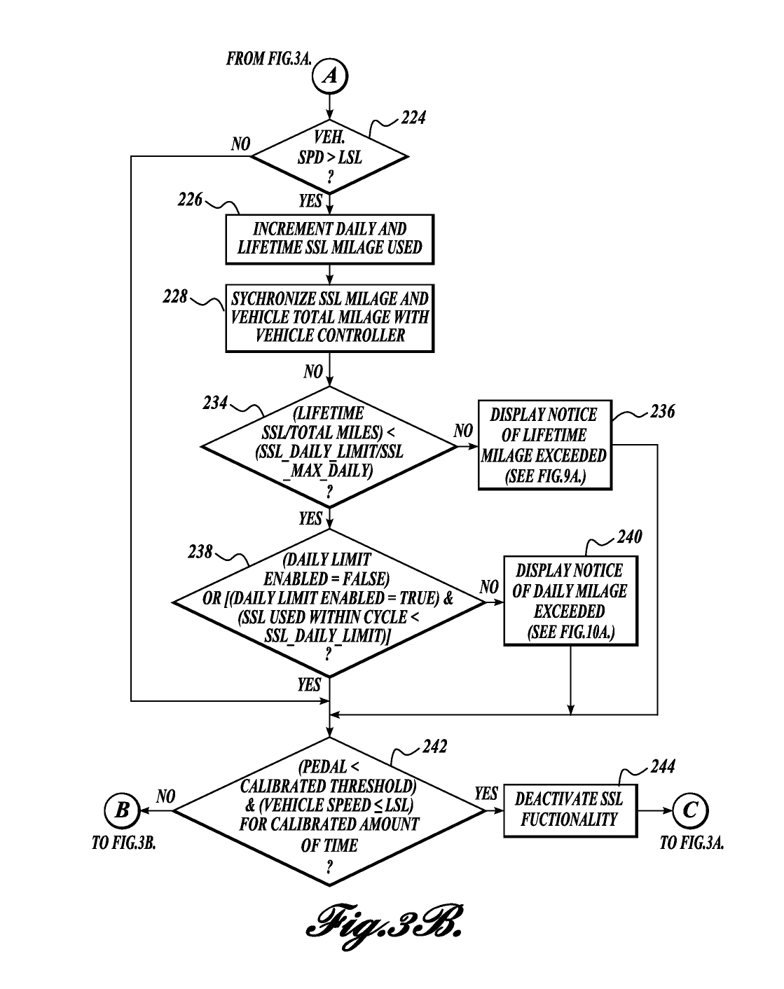

FIGS. 3A-3B illustrate one embodiment of a method 200 for providing a flexible maximum vehicle speed according to various aspects of the present disclosure. From a start block, the method proceeds to a decision block 202. At decision block 202, the ECU 106 determines whether the SSL is enabled. If the SSL is not enabled, the method 200 proceeds to block 204, and the ECU 106 controls the vehicle speed so that the maximum allowed speed is the LSL. If the SSL is enabled, the method 200 proceeds to decision block 206.

At block 206, the ECU 106 determines if the SSL activation has been requested. In one embodiment, the vehicle operator requests SSL activation by performing a “double tap” (described later) of the accelerator. It will be appreciated that an SSL activation request is not limited to the disclosed accelerator double tap, but can be any operator generated input that sends a signal to the ECU 106 via the previously described operator input sensor module 112. If SSL activation has not been requested, the method 200 proceeds to block 204, and the ECU 106 controls the vehicle speed so that the maximum allowed speed is the LSL. If SSL activation has been requested, the method 200 proceeds to decision block 208.

In block 208, the ECU 106 determines whether or not the actual vehicle speed (V_{actual}) is greater than or equal to the LSL less a calibrated offset, i.e., if V_{actual} is within a predetermined range near LSL. If V_{actual}<LSL-calibrated offset, then the method 200 proceeds to block 204, and the ECU 106 controls the vehicle speed so that the maximum allowed speed is the LSL. If V_{actual}≧LSL-calibrated offset, then the method proceeds to decision block 210. In other words, an activation request is only effective if the vehicle is traveling at or near LSL.

In block 210, the ECU 106 compares a lifetime SSL distance ratio (SSL Lifetime Total Distance/Vehicle Lifetime Distance) versus a daily SSL distance ratio (SSL Daily Distance/SSL Max Daily Distance). If the ECU 106 determines that the lifetime distance ratio is greater than or equal to the daily SSL distance ratio, then the method 200 proceeds to block 212, wherein the ECU 106 controls the operator display 102 to indicate that a speed limiter bonus is unavailable. FIG. 5A shows an example of an operator display 300 displaying text 302 indicating that the reserve speed is unavailable because the lifetime distance ratio is greater than the daily SSL distance ratio, i.e., the lifetime distance ratio has been exceeded. FIG. 5B shows an alternate embodiment of an operator display 304 displaying a combination of text and graphics 306 to indicate that the reserve speed is unavailable because the lifetime distance ratio has been exceeded. It will be appreciated that the illustrated displays 300 and 304 are exemplary only and should not be considered limiting. In this regard it is contemplated that all of the displays described herein can relay information to the vehicle operator using any number of different combinations of text and or graphics. Moreover, the use of audio signals, haptic technology, or any other known configuration suitable for relaying information to the vehicle operator may be utilized and should be considered within the scope of the present disclosure The method 200 then proceeds to block 204, and the ECU 106 controls the vehicle speed so that the maximum allowed speed is the LSL.

Returning to block 210, if the ECU 106 determines that the lifetime distance ratio is less than the daily SSL distance ratio, then the method 200 proceeds to block 214. In block 214, the ECU 106 determines if vehicle operation has been such that an SSL daily limit condition prevents activation of the SSL. The SSL daily limit is a distance limit over a predefined cycle. Depending upon the needs of the owner or operator, some vehicles will require that the SSL daily limit has not been reached as a condition to activate SSL functionality. If the SSL daily limit is set to be a condition to activate the SSL, and the SSL daily limit has been reached, then the method 200 proceeds to block 216.

In block 216, the ECU 106 controls the operator display 102 to indicate that reserve speed is unavailable. FIG. 6A shows an example of an operator display 300 showing text 302 indicating that reserve speed is unavailable because the SSL daily limit has been exceeded. The text 302 also indicates the distance remaining until the SSL daily limit resets, i.e. reserve speed will once again be available. FIG. 6B shows an alternate display 304 showing a combination of text and graphics 306 indicating that reserve speed is unavailable because the SSL daily limit has been exceeded. The method 200 then proceeds to block 204, and the ECU 106 controls the vehicle speed so that the maximum allowed speed is the LSL.

Referring back to block 214, if the SSL daily limit is not set to be a condition to activate the SSL, or if the SSL daily limit is set to be a condition to activate the SSL and the SSL daily limit has not been reached, then the method 200 proceeds to block 218. In block 218, the ECU activates the SSL function. The method then proceeds to block 220.

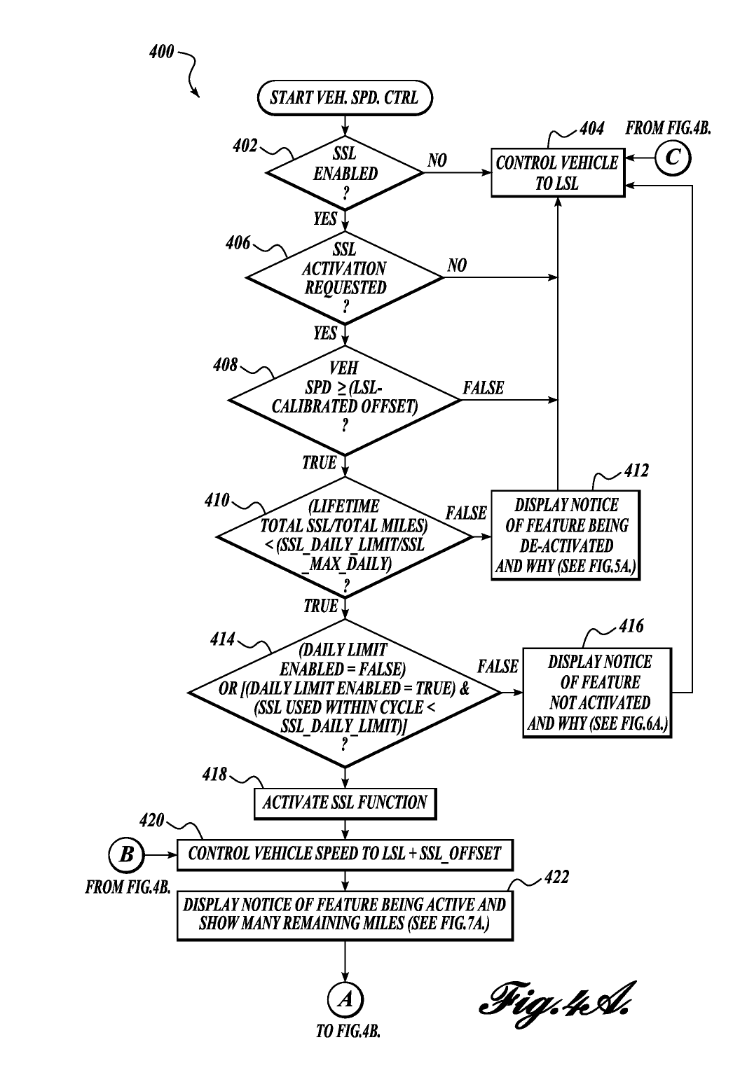

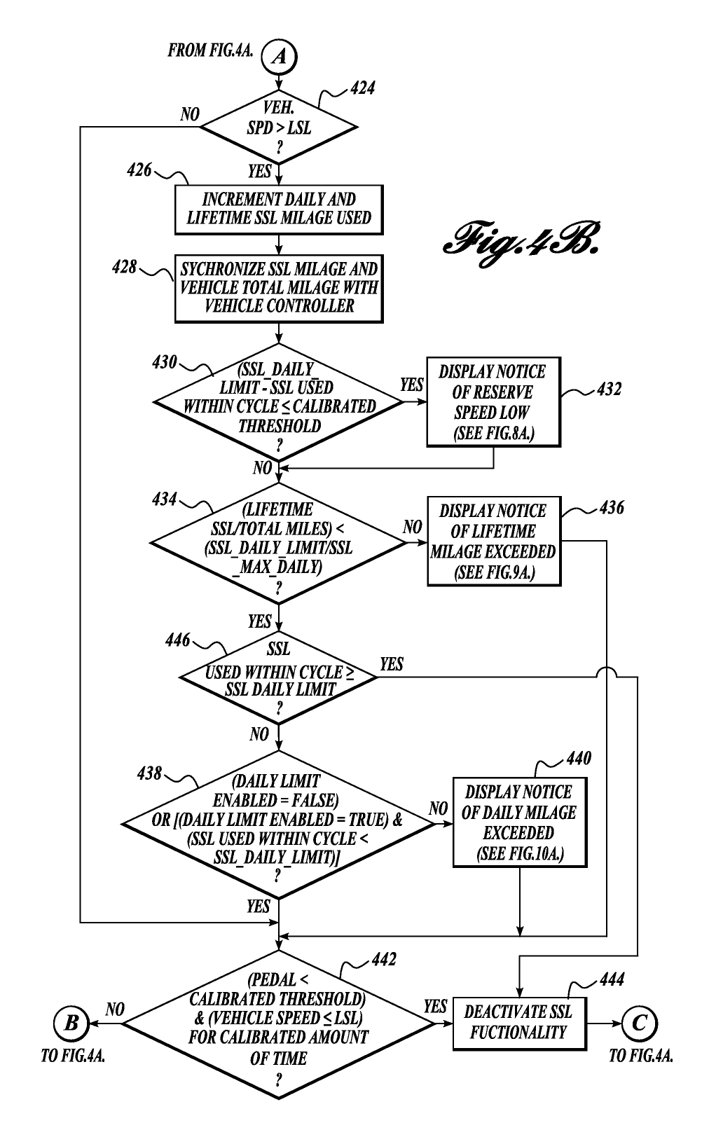

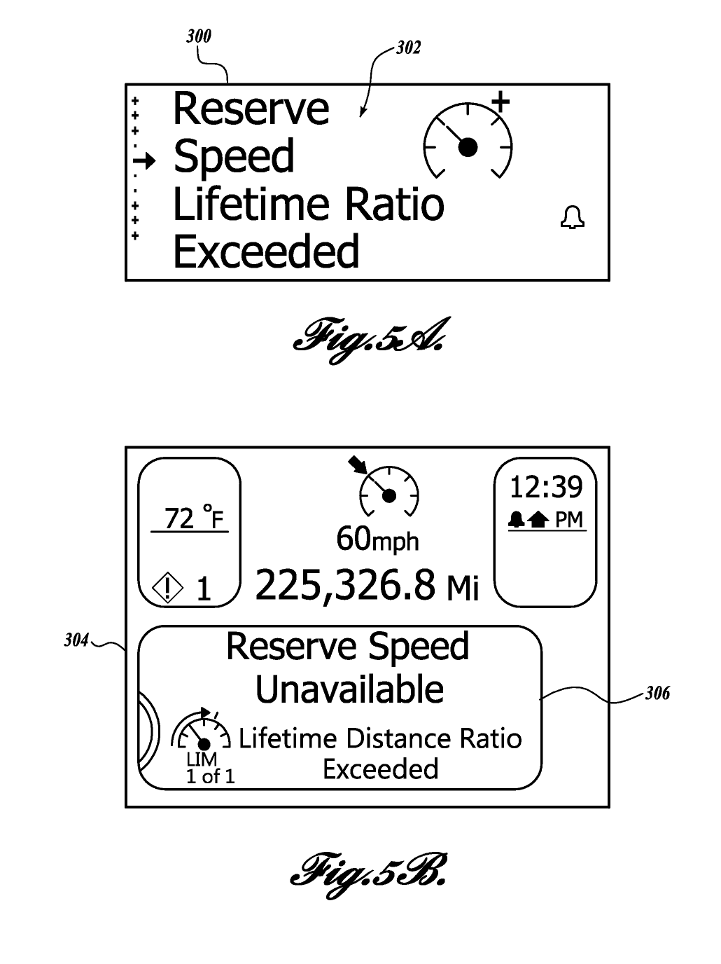

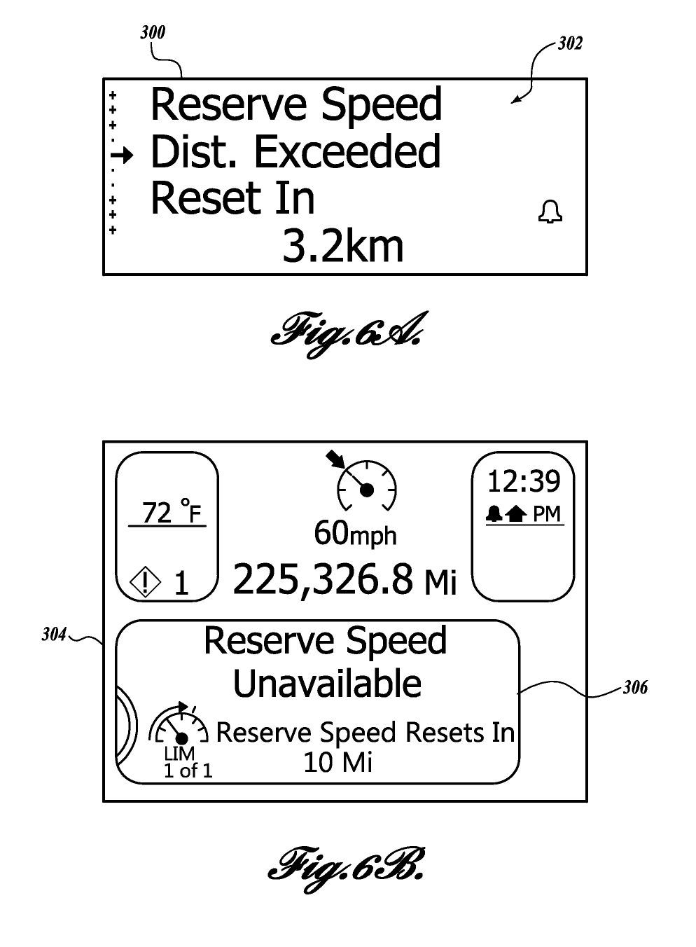

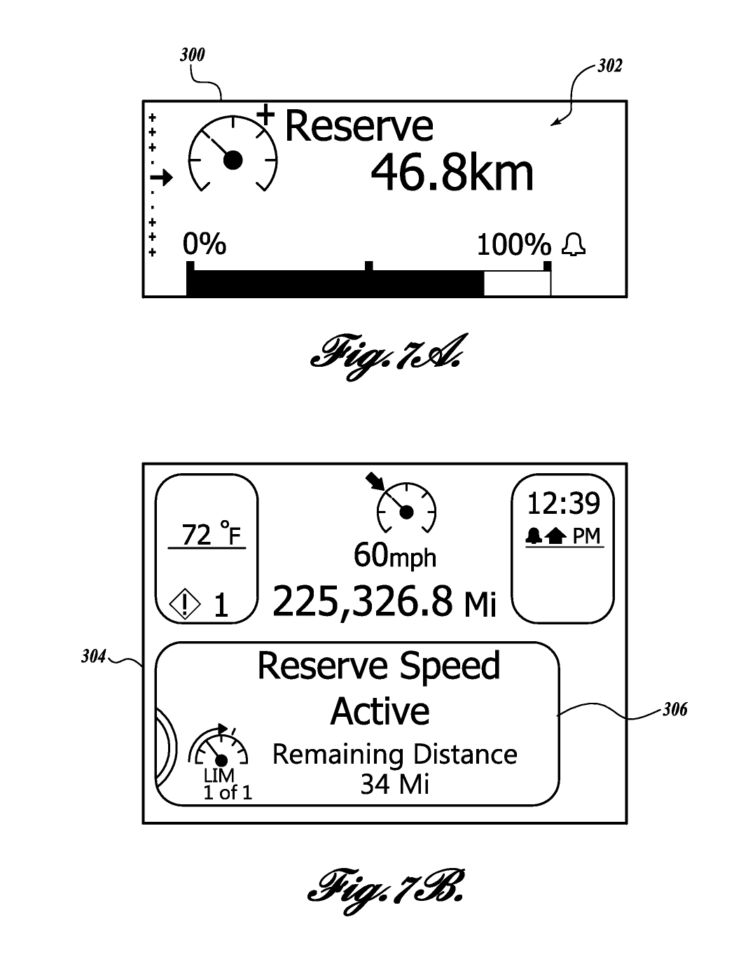

In block 220, the ECU 106 controls the speed control module 116 to limit vehicle speed to LSL+SSL Offset, i.e., STSL. With the SSL activated, and the vehicle speed limited to STSL, the method proceeds to block 222. In block 222, the ECU 106 controls the operator display 102 to indicate that the SSL is activated and how many mile of SSL activation remain. FIG. 7A shows an example of an operator display 300 displaying text and graphics 310 indicating that reserve speed is active, the distance that reserve speed may remain active for the present cycle, and the percentage of total reserve speed still available for the present cycle. FIG. 7B shows an alternate display 304 displaying text and graphics 306 to indicate that reserve speed is active and the distance that reserve speed may remain active, and the percentage of total reserve speed still available being.

The method 200 proceeds next to block 224. Beginning at block 224, the ECU 106 monitors various vehicle conditions to determine whether or not the SSL functionality will remain activated. In block 224, if the ECU 106 determines if V_{actual}≦LSL, then the method 200 proceeds to block 242. If V_{actual}<LSL, then the method 200 proceeds to block 226.

In blocks 226 and 228, the increment daily and lifetime SSL mileages are sensed and synchronized with the information stored in the vehicle performance profile store 104. The method then proceeds to block 234.

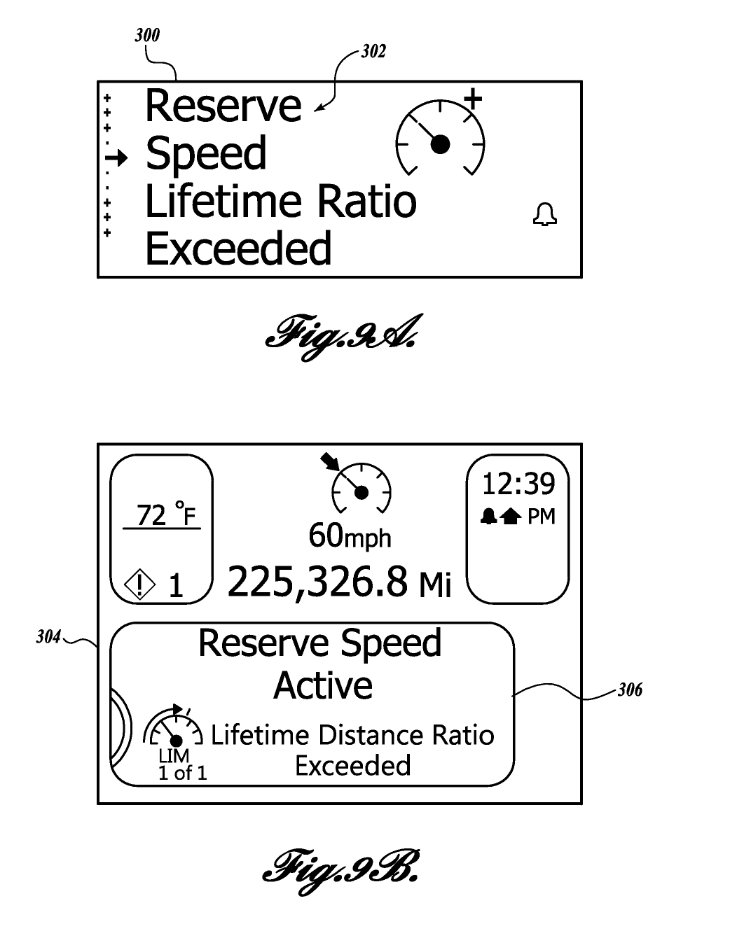

In block 234, similar to block 210, the ECU 106 compares a lifetime SSL distance ratio (SSL Lifetime Distance/Vehicle Lifetime Distance) to a daily SSL distance ratio (SSL Daily Distance/SSL Max Daily Distance). If the ECU 106 determines that the lifetime distance ratio is greater than or equal to the daily SSL distance ratio, then the method 200 proceeds to block 236, wherein the ECU 106 controls the operator display 102 to indicate that the lifetime mileage has been exceeded. FIG. 9A shows an example of an operator display 300 showing text 302 to indicate that the lifetime distance ratio is greater than the daily SSL distance ratio, i.e., the reserve speed lifetime ratio has been exceeded, while SSL functionality was enabled. FIG. 9B shows an alternate display 304 showing text and graphics 306 to indicate that the reserve speed lifetime ratio has been exceeded while SSL functionality was enabled. The method 200 then proceeds to block 242.

Returning to block 234, if the ECU 106 determines that the lifetime distance ratio is less than the daily SSL distance ratio, then the method 200 proceeds to block 238. In block 238, similar to block 214, the ECU 106 determines if vehicle operation has been such that an SSL daily limit requires that SSL functionality be deactivated. As previously noted, the SSL daily limit is a distance limit over a predefined cycle. If the SSL daily limit is set to be a condition to activate the SSL, and the SSL daily limit has been reached, then the method 200 proceeds to block 240.

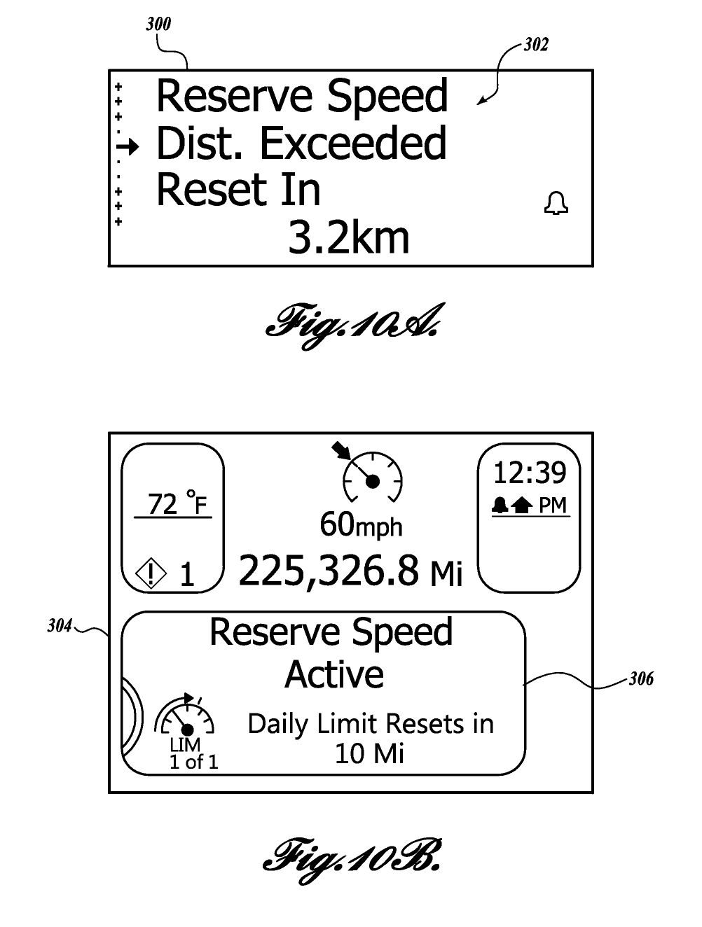

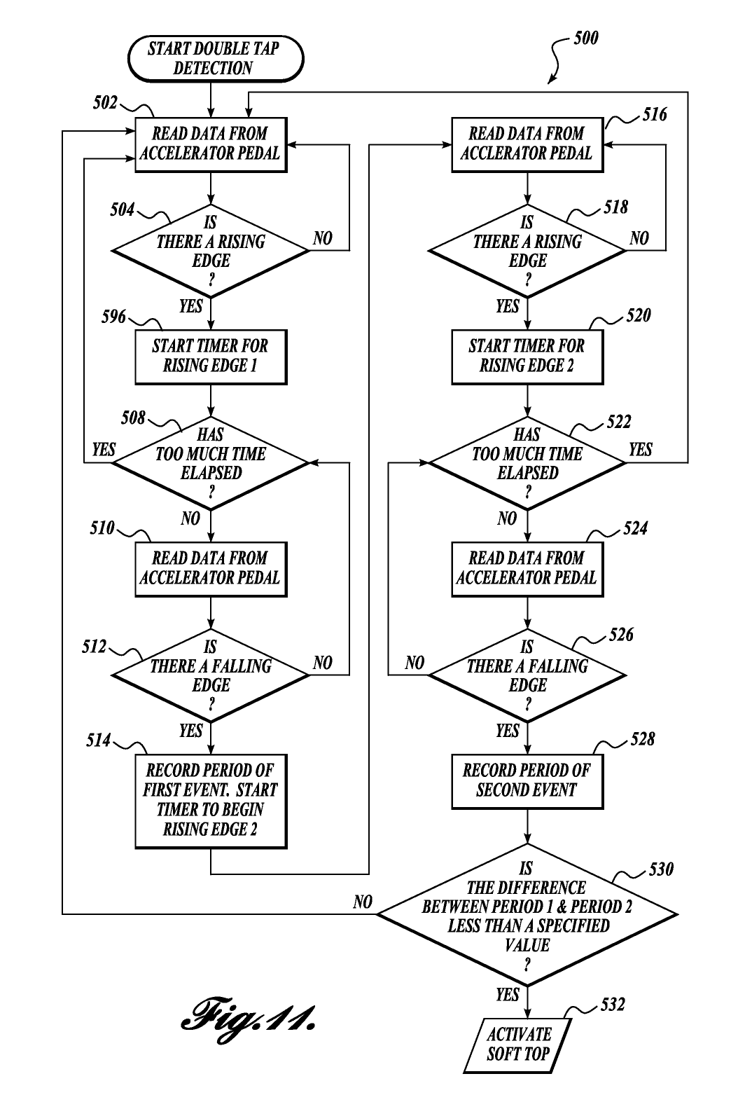

In block 240, the ECU 106 controls the operator display 102 to indicate that the SSL daily limit has been exceeded while SSL functionality was enabled. FIG. 10A shows an example of an operator display 300 that displaying text 302 that indicates that the SSL daily limit has been exceeded and the distance remaining until the SSL daily limit is reset. FIG. 10B shows and alternate display 304 showing text and graphics 306 that show that reserve speed is active and the distance until the SSL daily limit resets. The method 200 then proceeds to block 242.

In block 242, to which the method 200 can arrive via any of blocks 224, 236, 238, and 240, the ECU 106 determines whether or not to proceed with deactivation of SSL functionality. Even though daily or lifetime SSL limits have been exceeded, in order to provide increased safety, the SSL functionality is not always immediately deactivated. For example, it is possible that the daily or lifetime SSL limits are exceeded during a time when a vehicle operator is executing a passing maneuver that briefly requires the vehicle to exceed the LSL. If the SSL functionality were disabled immediately upon exceeding the daily or lifetime SSL limits, the maximum vehicle speed would decrease to the LSL during the maneuver, creating a potentially dangerous situation in which the vehicle operator does not have sufficient vehicle speed to safely complete the maneuver.

Prior to deactivating the SSL functionality, ECU 106 checks certain operating parameters to eliminate the possibility that deactivating the SSL functionality will create an unsafe operating condition. Specifically, the ECU 106 checks the pedal position and the vehicle speed for a predetermined amount of time. If the accelerator pedal is depressed beyond a certain position, or if V_{actual}>LSL, the possibility exists that the vehicle operator is actively using the SSL functionality. Because disabling SSL functionality when the operator is actively using the increased vehicle speed could potentially present unsafe operation conditions, if, for a predetermined amount of time, the accelerator pedal is depressed beyond a certain position, or if V_{actual}>LSL, then the method 200 proceeds back to block 220, and the SSL functionality remains activated. If, for a predetermined amount of time, the accelerator pedal is not depressed beyond a certain position, and if V_{actual}≦LSL, then the method 200 then proceeds to block 244, and the ECU 106 deactivates SSL functionality. The method 200 proceeds to block 204, during which the vehicle speed is limited to LSL until the next time the vehicle operator attempts to activate SSL functionality.

Referring now to FIGS. 4A and 4B, an alternate embodiment of a method 400 for providing a flexible maximum vehicle speed is disclosed. Unlike the previously described method 200, the method 400 of FIGS. 4A and 4B allows for SSL deactivation provided that the vehicle operator is given sufficient warning of the pending deactivation. In this embodiment, the warning provided to the driver of pending SSL deactivation allows the driver to avoid operating conditions that could potentially be dangerous during SSL deactivation, e.g., a passing maneuver.

The method 400 illustrated in FIGS. 4A and 4B is similar to the previously described method 200 shown in FIGS. 3A and 3B. In this regard the steps labeled with 400-series reference numbers (4XX) in FIGS. 4A and 4B correspond to the steps labeled with 200-series reference numbers (2XX) in FIGS. 3A and 3B. For the sake of brevity, the description of the method 400 proceeds with an emphasis on the additional steps contained in method 400 with the understanding that the steps not described in detail correspond to the steps of the previously described method 200.

Referring to FIG. 4B, the method 400 proceeds from blocks 426 and 428, in which the increment daily and lifetime SSL mileages are sensed and synchronized with the information stored in the vehicle performance profile store 104, to block 430.

In block 430, the ECU 106 determines if the reserve speed used within the current cycle is approaching the SSL daily limit. To accomplish this, the ECU 106 subtracts the reserve speed used within the cycle from the SSL daily limit and determines if it has reached a predetermined threshold. If the difference between the amount of reserve speed used within the current cycle and the SSL daily limit has reached the predetermined threshold, the method 400 proceeds to block 432. Otherwise, the method 400 proceeds to block 434.

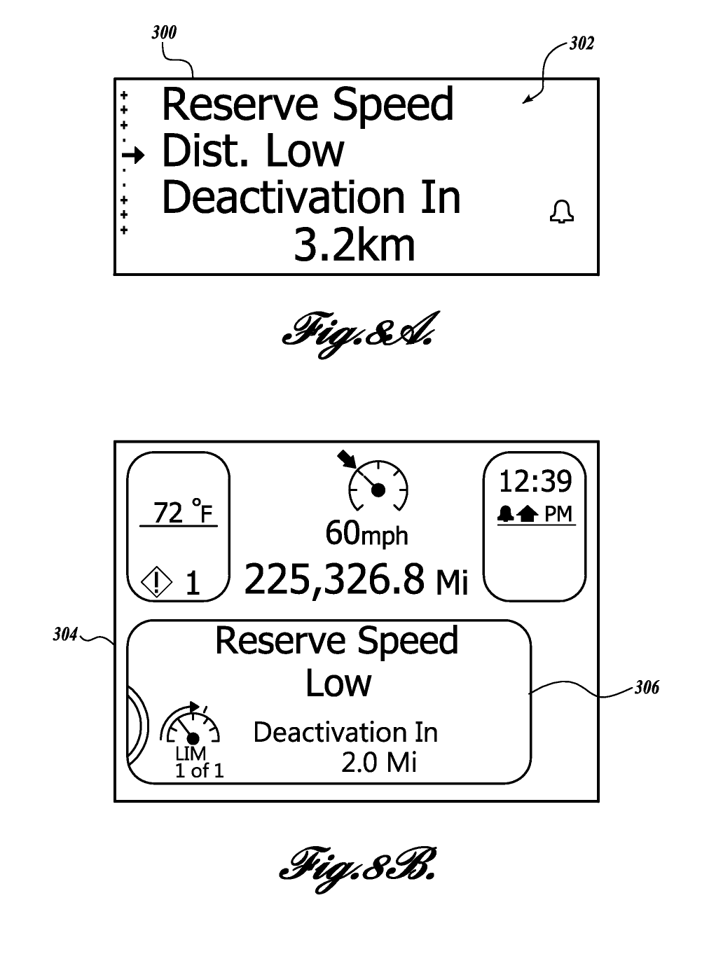

In block 432, the ECU 106 controls the operator display 102 to indicate that the available reserve speed is running low and how many mile of SSL activation remain. Thus, the driver is alerted to the pending SSL deactivation and can avoid maneuvers that could potentially be dangerous if performed during SSL deactivation. FIG. 8A shows an example of an operator display 300 displaying text 302 indicating that reserve speed is running low and how many miles of reserve speed remain until SSL deactivation. FIG. 8B shows an alternate display 304 showing text and graphics 306 to indicate that reserve speed is running low and how many miles of reserve speed remain until the SSL functionality is deactivated. The method then proceeds to block 434.

In block 434, the ECU 106 compares a lifetime SSL distance ratio (SSL Lifetime Distance/Vehicle Lifetime Distance) to a daily SSL distance ratio (SSL Daily Distance/SSL Max Daily Distance). If the lifetime distance ratio is greater than or equal to the daily SSL distance ratio, then the method 400 proceeds to block 436, wherein the ECU 106 controls the operator display 102 to indicate that the lifetime mileage has been exceeded, such as shown in FIGS. 9A and 9B. The method 400 then proceeds to block 442. If the lifetime distance ratio is less than the daily SSL distance ratio, then the method 400 proceeds to block 446.

In block 446, the ECU 106 compares the SSL Daily Distance (the reserve speed used within the current cycle) to the SSL Max Daily Distance. If the SSL Daily Distance is greater than or equal to the SSL Max Daily Distance, then the method 400 proceeds to block 444, and the SSL is deactivated. If the SSL Daily Distance is less than the SSL Max Daily Distance, then the method 400 proceeds to block 438 and continues in a manner similar to method 200.

As previously described with respect to exemplary methods 200 and 400, the SSL functionality is enabled when the vehicle operator provides an activation request at a time when SSL functionality is available. FIG. 10 shows one exemplary method 500 for requesting SSL activation. The illustrated method 500 is a “double-tap” of the accelerator pedal 40 by the vehicle operator. As discussed in detail below, the ECU 106 collects data from the accelerator pedal position sensor 50 regarding the position of the accelerator pedal 40 over a period of time to determine that the movement of the accelerator pedal is an affirmative activation request by the vehicle operator and not simply movement incidental to the operation of the vehicle.

From a start block, the method proceeds to a decision block 502. At decision block 502, the ECU 106 collects data about the accelerator pedal 40 position and movement from the accelerator pedal position sensor 50. The method 500 proceeds to decision block 504 to determine if there is a rising edge. As used herein, a rising edge refers to an edge of the accelerator pedal 40, indicating that the accelerator pedal is being release, i.e., the accelerator pedal is rising. If a rising edge is not detected, the method 500 returns to block 502. If a rising edge is detected, then the method 500 proceeds to block 506.

In block 506, the ECU 106 starts timing the duration of the rise of the accelerator pedal 40. The rise of the accelerator pedal 40 ends when a falling edge is detected, i.e., when the accelerator pedal 40 is depressed. In decision block 508, which occurs while the accelerator pedal 40 is rising, the ECU 106 determines if the accelerator pedal has been rising for longer than a predetermined length of time, i.e., is the accelerator pedal rising at too slow a rate to indicate part of a SLL activation request. If too much time has elapsed, then the method 500 returns to block 502. If too much time has not elapsed, then in block 510, the ECU 106 continues to determine if the pedal is still rising by based on information from the accelerator pedal position sensor 50.

In block 512, if the ECU 106 does not detect a falling edge, i.e., the ECU does not detect that the accelerator pedal 40 is being depressed, then the method 500 returns to block 508. If a falling edge is detected, i.e., the accelerator pedal 40 is being depressed, then the method 500 proceeds to block 512, and the duration of this first period during which the accelerator pedal was rising is stored. The method 500 next proceeds to block 516.

The method 500 proceeds from block 516 through block 526 in the same manner as block 502 through block 512. That is, the ECU 106 continuously monitors a second rising of the accelerator pedal 40 to determine the amount of time that the accelerator pedal rises before it begins to fall, i.e., before the operator depresses the pedal. If the duration of this event is too long, then the method 500 returns to block 502. If the second rising of the accelerator pedal ends and does not take longer than a predetermined amount of time, the method 500 proceeds to block 528.

In block 528 the duration of this second period during which the accelerator pedal was rising is stored. The method 500 then proceeds to block 530, wherein the difference between durations of the first and second periods is determined. If the difference between the two periods is greater than a specified value, then the method 500 returns to block 502. If the difference between the two periods is less than a specified value, i.e., the periods are similar in duration, then the method 500 proceeds to block 532, and the SSL is activated.

Thus, as described above, the illustrated method 500 for requesting SSL activation allows a vehicle operator to request SSL activation by depressing, i.e., “tapping.” the accelerator pedal twice, with each “tap” taking less than a predetermined amount of time and wherein the two “taps” are generally of the same duration.

The disclosed method is exemplary only and should not be considered limiting. In this regard, the number of accelerator “taps,” the duration thereof, and the allowable differences in duration can vary. Moreover, alternate methods of requesting SSL activation are contemplated and should be considered within the scope of the present disclosure. Buttons, toggle switches, touch screens, and other known input configurations can be utilized in conjunction with the presently disclosed methods.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

The embodiments of the invention in which an exclusive property or privilege is claimed are defined as follows:

1. A method of limiting a vehicle speed, comprising:
(a) limiting the vehicle speed to a predetermined limit during a standard operating mode; and
(b) selectively engaging an override mode in response to an operator-generated input, the vehicle speed exceeding the predetermined speed limit during the override mode, wherein the override mode is not available after the vehicle has traveled a predetermined distance limit in the override mode.

2. The method of claim 1, wherein the distance limit is maximum distance traveled during a predetermined time.

3. The method of claim 2, wherein the predetermined time is 24 hours.

4. The method of claim 1, wherein the distance limit is a maximum distance traveled during the lifetime of the vehicle.

5. The method of claim 1, further comprising the step of providing a signal that the override mode is available.

6. The method of claim 5, wherein the signal includes an indication of a distance remaining in the override mode before the distance limit is reached.

7. The method of claim 1, wherein the override condition is not available after the vehicle has traveled a predetermined distance limit at a speed greater than the predetermined speed limit while in the override condition.

8. The method of claim 1, wherein the override condition is deactivated when the distance limit is reached.

9. The method of claim 8, wherein the method further comprises providing a signal that deactivation is pending.

10. The method of claim 1, wherein the override condition is deactivated when (1) the distance limit has been exceeded and (2) the vehicle is traveling below the predetermined speed limit.

11. The method of claim 10, wherein the override condition is deactivated when an operator-generated condition occurs.

12. The method of claim 11, wherein the operator-generated condition comprises maintaining an accelerator pedal position within a predetermined range for a predetermined amount of time.

13. A method of limiting a vehicle speed, comprising:
(a) limiting the vehicle speed to a predetermined limit during a standard operating mode; and
(b) providing an operator input to selectively engage an override mode, the vehicle speed exceeding the predetermined speed limit during the override condition;
(c) disengaging the override mode when a predetermined disengagement condition is met.

14. The method of claim 13, wherein the override mode is engageable during an override condition.

15. The method of claim 14, wherein the override condition comprises the override mode being engaged for less than a predetermined distance during a cycle.

16. The method of claim 14, wherein the override condition comprises the override mode being engaged for less than a predetermined distance during the vehicle lifetime.

17. The method of claim 13, wherein providing the operator input comprises depressing an accelerator pedal a first and second time.

18. The method of claim 17, wherein a time to depress the accelerator pedal the first time is defines a first duration, the first duration being less than a first predetermined limit.

19. The method of claim 18, wherein a time to depress the accelerator pedal the second time is defines a second duration, the second duration being less than a second predetermined limit.

20. The method of claim 19, wherein the first predetermined limit is approximately equal to the second predetermined limit.

21. The method of claim 19, wherein a difference between the first duration and the second duration is less than a predetermined length of time.
